(19) United States
(12) Patent Application Publication
(10) Pub. No.: US 2016/0289527 A1
(43) Pub. Date: Oct. 6, 2016

(54) CONTROL OF SUSTAINED CASING PRESSURE IN WELLBORE ANNULI

(71) Applicant: ALBEMARLE CORPORATION, Baton Rouge, LA (US)

(72) Inventors: Kristina L. Butler, Baton Rouge, LA (US); Zhongxin Ge, Baton Rouge, LA (US); Joseph O'Day, Baton Rouge, LA (US); John C. Parks, Baton Rouge, LA (US); Michael J. Wilhelm, Baton Rouge, LA (US); Tse-Chong Wu, Baton Rouge, LA (US); Charles Daniel Varnado, JR., Denham Springs, LA (US)

(21) Appl. No.: 15/038,109

(22) PCT Filed: Dec. 9, 2014
(86) PCT No.: PCT/US2014/069285

§ 371 Date: May 20, 2016

Related U.S. Application Data
(60) Provisional application No. 61/920,103, filed on Dec. 23, 2013.

(51) Int. Cl. C09K 8/035

(52) U.S. Cl. CPC C09K 8/035

(57) ABSTRACT

This invention provides a method for minimizing or relieving a sustained casing pressure in an annulus of a wellbore, where the annulus contains a first fluid having a density. The method comprises introducing a second fluid into the annulus. The second fluid has a density greater than the density of the first fluid and the second fluid is immiscible with the first fluid. The method is characterized in that the second fluid comprises at least one halogen-containing organic compound. The halogen-containing organic compound has one or more halogen atoms selected from fluorine, chlorine, bromine, and iodine, with the proviso that at least one of the halogen atoms is chlorine, bromine, or iodine.

### TECHNICAL FIELD

This invention relates to minimizing or relieving sustained casing pressure in the annulus of a wellbore by introduction of a substantially immiscible fluid into the annulus of the wellbore.

### BACKGROUND

When drilling a wellbore, a pipe is inserted and is generally encased within a larger-diameter pipe (casing), forming a casing string or part of a casing string. The space between the pipes forms an annulus, which is typically sealed at the bottom with cement; the annulus is normally filled with an annular fluid (casing fluid), usually composed mainly of a drilling fluid or completion fluid. Annular fluids often contain components such as preflush liquids or spacer liquids. Over time, pressure can build up in the annulus (inside the casing); the excess pressure build-up in the casing is referred to as the sustained casing pressure. One characteristic of sustained casing pressure is that the pressure rebuilds if the excess pressure is relieved. The sustained casing pressure problem is well known in the oilfield industry.

Sustained casing pressure is caused by gas migration through cement imperfections (cracks, channels, microannuli, etc.) into the annular volume between casings. The sustained casing pressure significantly increases the chances that the casing string will fail, with catastrophic consequences to the operation of the well, such as a well blowout or other uncontrolled event that may result in significant loss of property, environmental impact, and potentially loss of life. Venting off the pressure is not a long-term solution, because the pressure rebuilds, and the gases emitted are usually pollutants.

A solution that has been employed to mitigate the sustained casing pressure problem is the introduction of a secondary fluid (kill fluid) into the annular fluid. The secondary fluid has higher density than the annular fluid; secondary fluids are usually high density brines. See in this connection U.S. Pat. No. 6,959,767 and U.S. 2008/135302. The high-density brines are at least partially miscible with the annular fluid. One reason for using a fluid having a higher density than the annular fluid is that the denser fluid is expected to travel downward through the annular fluid and rest on top of the cement to slow or block the migration of gases into the annular fluid. Miscible fluids do not perform well in this displacement of the annular fluid in contact with the cement. Other fluids, typically aqueous mixtures, have also been suggested; see U.S. 7,441,559.

Fluids employed to decrease or eliminate the sustained casing pressure desirably have a low toxicity to mammals and aquatic organisms. It is also desirable that such fluids are stable under conditions in the wellbore annulus, have a density higher than that of the fluid in the annulus, flow readily, are not flammable, and are minimally or not corrosive.

In the Final Report submitted to the U.S. Department of the Interior, Minerals Management Service, Jul. 31, 2001, by Andrew K. Wojtanowicz, Somei Nishikawa, and Xu Rong, entitled Diagnosis and Remediation of Sustained Casing Pressure in Wells, experiments were reported in which immiscible fluids were tested. More specifically, laboratory-scale tests injecting aqueous brines or aqueous bentonite into white oil were promising; however, in most situations, the fluid present in the annulus is an aqueous solution.

Thus, more effective secondary fluids for control of sustained casing pressure are needed.

### SUMMARY OF THE INVENTION

This invention provides methods for minimizing or relieving the sustained casing pressure in a wellbore annulus (or casing string). This is achieved by introduction of a fluid that is immiscible with, and denser than, the annular fluid into the wellbore annulus. In the present invention, the fluid that is denser than the annular fluid and immiscible with the annular fluid is one or more halogen-containing organic compounds. Advantageously, halogen-containing organic compounds are generally immiscible with aqueous fluids while being relatively dense, and have other desired properties, most often including not being flammable, being minimally or not corrosive, being stable under downhole conditions, and/or having a desirable viscosity. Properties of halogen-containing organic compounds will vary; for example, some halogen-containing organic compounds may have higher densities and higher viscosities, while other halogen-containing organic compounds may have lower densities and lower viscosities, or higher densities and lower viscosities.

An embodiment of this invention is a method for minimizing or relieving a sustained casing pressure in an annulus of a wellbore. The annulus contains a first fluid having a density, and the method comprises introducing a second fluid into the annulus. The second fluid has a density greater than the density of the first fluid, and the second fluid is immiscible with the first fluid. The method is characterized in that the second fluid comprises at least one halogen-containing organic compound. The halogen-containing organic compound has one or more halogen atoms selected from fluorine, chlorine, bromine, and iodine, with the proviso that at least one of the halogen atoms is chlorine, bromine, or iodine.

These and other embodiments and features of this invention will be still further apparent from the ensuing description and appended claims.

### FURTHER DETAILED DESCRIPTION OF THE INVENTION

As used throughout this document, the term “annular fluid” refers to the first fluid, which is present in the wellbore annulus before the second fluid is introduced, unless otherwise noted. Throughout this document, the term “kill fluid” refers to the second fluid, which is introduced into the wellbore annulus.

In the practice of the invention, the second fluid can be introduced at the wellhead or below the surface of the annular fluid (usually via a tube inserted into the annular fluid). It has been observed that the introduction method can affect some of the physical aspects of the kill fluid, such as the size and shape of the kill fluid in the annulus, and gas entrapment in the kill fluid. Subsurface introduction of the kill fluid is generally preferred because larger droplets of kill fluid are formed in the annular fluid. Introduction of the kill fluid can be incremental or continuous. In some embodiments, continuous introduction of the kill fluid is preferred.

Introduction of the kill fluid into the wellbore annulus is usually considered to be the same as introducing the kill fluid into the annular fluid because the wellbore annulus is typically filled with annular fluid. When introducing the kill fluid, some of the annular fluid is normally removed from the wellbore annulus. The introduction of the second fluid into the wellbore annulus usually causes at least a portion of the first fluid to be replaced. The replacement of the annular fluid can be partial or complete, as needed or desired. The kill fluid can be introduced incrementally or continuously. Preferably, the kill fluid introduction is maintained until the sustained casing pressure is reduced to the desired level, usually to about zero.

In some instances, it may be desirable to have the kill fluid drop to the bottom of the annulus, but dropping of the kill fluid to the bottom of the annulus is not necessary to minimize or relieve the sustained casing pressure.

Normally and preferably, the kill fluid is liquid at ambient conditions so it can be readily transferred (pumped) into the wellbore annulus. Thus, the halogen-containing compound or mixture of halogen-containing compounds used as the kill fluid is preferably a liquid.

The first fluid (annular fluid or casing fluid) is typically an aqueous well fluid, comprised predominately of a drilling fluid (drilling mud) or a completion fluid. Completion fluids are generally aqueous brines having densities of about 9 ppg (pounds per gallon; 1.08 kg/L) or greater, often as high as about 19 ppg (2.28 kg/L). Drilling fluids are usually non-Newtonian aqueous fluids containing a variety of organic and inorganic components which include, but are not limited to, density enhancers, viscosity control agents, gelling agents, filtration control agents, alkalinity aids, dispersants, defoamers, contaminant removal chemicals, flocculating agents, formation stabilizing agents, surfactants, lost circulation additives, lubricants, spotting fluids, corrosion inhibitors, thermal stabilizers, oxygen scavengers, drilling rate enhancers, scale inhibitors, antifreeze agents, and bactericides. Drilling fluids have densities of about 9 ppg (1.08 kg/L) or greater, sometimes as high as about 20 ppg (2.40 kg/L), typically between 10 ppg (1.20 kg/L) and 15 ppg (1.80 kg/L).

While aqueous annular fluids are referred to herein as “drilling fluids” or “completion fluids”, it is understood that they may contain other components, such as preflush liquids, spacer liquids, surfactants, scale removers, corrosion inhibitors, reactive solids such as bentonite, clays and shales from drilled formations, and polymeric materials; inert solids such as barite (BaSO₄) and hematite (Fe₂O₃); dispersants, such as lignosulfonates; and other ingredients.

Immiscibility refers to the non-mixing or substantial non-mixing of the organic halogen-containing compounds and the (aqueous) annular fluid. One indication of immiscibility is the solubility of the halogen-containing compound in water, in the sense that low or negligible water solubilities tend to indicate immiscibility with the annular fluid. Generally, the water solubility of the halogen-containing compound is less than about 0.1 g/mL, preferably about 0 g/mL to about 0.1 g/mL, and more preferably about 0 to about 0.05 g/mL. Note that literature information often states “insoluble” rather than a solubility of 0 g/mL. The annular fluid is usually an aqueous solution or suspension, and the ingredients present in the annular fluid may influence the miscibility of the halogen-containing compound with the annular fluid.

As there is a wide variation in well fluids, the minimum difference in density between the first fluid and the second fluid that is effective is expected to vary from system to system. Experiments to date indicate that for completion fluids, a kill fluid density about 0.5 ppg (0.06 kg/L) higher than the annular fluid density is enough to be effective, and kill fluids having densities higher than the density of the annular fluid by about 0.5 ppg or more are preferred. For drilling fluids, at least in the systems studied, it appears that the kill fluid density needs to be higher than the density of the annular fluid by about 1.0 ppg (0.12 kg/L) or more. In some systems, it has been observed that when the annular fluid is a drilling fluid, the kill fluid density needs to be more than 1.5 ppg (0.18 kg/L) higher than the density of the annular fluid.

A wide range of densities can be obtained by mixing two or more halogen-containing organic compounds together. Mixtures may also allow the attainment of other desired properties. For example, a high molecular weight halogen-containing compound may have a desirable toxicity profile but a high viscosity; mixing with a halogen-containing compound having a lower molecular weight may reduce the viscosity without having a significant impact on the toxicity profile. Another example is a high molecular weight halogen-containing compound with a desirable density profile but an undesired corrosion rate; mixing such a compound with a halogen-containing compound having a lower corrosion rate may form a fluid with a better corrosion rate while retaining a relatively high density.

Some of the halogen-containing organic compounds used in the practice of this invention, particularly the halogenated oligomers and polymers, the halogenated natural products, and the halogenated fatty acids and esters, are referred to as “halogenated” compounds without specifying the number of halogen atoms. This is due to the variability in the number of halogen atoms in such compounds. For example, in brominated polybutadiene, the amount of bromine in weight percent for the polybutadiene indicates the total amount of bromine present, although the number of bromine atoms on each polybutadiene chain may vary.

Compounds used in the practice of this invention may be halogenated in various patterns. Not all substitution variations may be listed. In other words, the absence of one isomer of, e.g., a tribrominated molecule, does not exclude that particular compound.

Throughout this document, the phrase “halogen-containing organic compound” is used interchangeably with the phrase “halogen-containing compound”. As used throughout this document, the term “organic” in the phrase “halogen-containing organic compounds” means compounds containing one or more carbon atoms. The terms “chlorine-containing compound”, “bromine-containing compound”, and “iodine-containing compound” are used in the same manner throughout this document.

The term “halogen-containing organic compound” refers to organic compounds containing a single halogen element when all of the halogen atoms in a compound are chlorine, bromine, or iodine, and refers to mixed-halogen organic compounds when there are atoms of two or more different halogen elements present in the compound. Preferred halogen-containing compounds include bromine-containing organic compounds, chlorine-containing organic compounds, and mixed-halogen organic compounds. In some embodiments, bromine-containing compounds are more preferred.

Mixtures of two or more halogen-containing organic compounds can be used as the kill fluid, and can be a mixture of, for example, two bromine-containing compounds, a mixture of a bromine-containing compound and a chlorine-containing compound, or a mixture of a bromine-containing compound and a mixed-halogen compound. The only requirement for such mixtures is that they are immiscible with, and denser than, the annular fluid to which they are introduced. Chlorine-containing organic compounds, bromine-containing organic compounds, iodine-containing organic compounds, and mixed-halogen organic compounds can all be used in mixtures of two or more halogen-containing organic compounds.

In the practice of this invention, several types of halogen-containing organic compounds can be used, including but not limited to, halogenated oils, halogenated natural products, halogenated fatty acids, halogenated fatty acid esters, halogenated oligomers and halogenated polymers, halogen-containing aromatic compounds, halogen-containing nonaromatic organic compounds, and halogen-containing ionic compounds. More particularly, types of chlorine-containing organic compounds include chlorinated oils, chlorinated natural products, chlorinated fatty acids, chlorinated fatty esters, chlorinated oligomers and chlorinated polymers, chlorine-containing aromatic compounds, chlorine-containing nonaromatic organic compounds, chlorine-containing ionic compounds, and mixtures of two or more of the foregoing; types of bromine-containing organic compounds include brominated oils, brominated natural products, brominated fatty acids, brominated fatty esters, brominated oligomers and brominated polymers, bromine-containing aromatic compounds, bromine-containing nonaromatic organic compounds, bromine-containing ionic compounds, and mixtures of two or more of the foregoing.

When a single halogen-containing organic compound is used as the kill fluid, the halogen-containing compound preferably has a halogen content of about 20 wt % to about 96 wt %. When the halogen-containing compound is a chlorine-containing compound, there is more preferably about 20 wt % to about 92 wt % chlorine in the compound. For iodine-containing compounds, there is more preferably about 40 wt % to about 77 wt % iodine in the compound. For the bromine-containing compounds, more preferably there is about 35 wt % to about 96 wt %, still more preferably about 40 wt % to about 96 wt %, even more preferably about 50 wt % to about 96 wt % bromine in the compound. In some embodiments, the bromine-containing compound has a bromine content of about 20 wt % or more, preferably about 35 wt % or more, more preferably about 40 wt % or more, and still more preferably about 50 wt % or more, bromine in the compound.

When a mixture of halogen-containing organic compounds is used, one or more of the component compounds can have less than 35 wt % halogen, provided the other component(s) has a greater amount of halogen, and the components are in proportions such that the overall amount of halogen in the mixture is about 35 wt % or more, preferably about 35 wt % to about 96 wt %, more preferably about 40 wt % to about 96 wt %, still more preferably about 50 wt % to about 96 wt %, halogen. In some embodiments, the mixture of halogen-containing organic compounds has an overall amount of halogen in the mixture of about 35 wt % or more, preferably about 40 wt % or more, more preferably about 50 wt % or more. In some embodiments, lower amounts of halogen are acceptable, if at least one solid weighting agent is present in the fluid in an amount that makes the density of the kill fluid higher than the density of the annular fluid.

Some of the halogen-containing compounds that can be used in the practice of this invention are solids at ambient temperature and pressure. Halogen-containing compounds that are solids at ambient temperatures and pressures include some halogen-containing oligomers, some halogen-containing polymers, many halogen-containing aromatic compounds, and a small number of halogen-containing nonaromatic compounds, especially those that are perhalogenated or nearly perhalogenated. Other halogen-containing compounds not within these categories may be solid at ambient temperature and pressure.

When the halogen-containing compound to be used according to the invention is a solid, combination with another component, to form a liquid mixture, is recommended and preferred. The component may be another halogen-containing compound or a small amount of a solvent. Large amounts of non-halogenated solvent can decrease the density of the mixture to an undesirable value.

Halogenated oils in the practice of this invention include partially or fully halogenated vegetable oils, in which all of the halogen atoms are either chlorine or bromine, or the halogen atoms are a mixture of any two or more halogen atoms when at least one of the halogen atoms is chlorine or bromine. Halogenated vegetable oils in which all of the halogen atoms are bromine or chlorine, or in which the halogen atoms are chlorine atoms and bromine atoms, are preferred. More preferred halogenated vegetable oils are brominated vegetable oils in which all of the halogen atoms are bromine

Suitable halogenated vegetable oils include partially halogenated vegetable oils having about 10 wt % to about 50 wt % halogen, preferably about 15 wt % to about 50 wt % halogen, more preferably about 20 wt % to about 50 wt % halogen. Halogenated vegetable oils include chlorinated soybean oil, brominated soybean oil, chlorinated flaxseed oil, brominated flaxseed oil, chlorinated canola oil, brominated canola oil, chlorinated olive oil, brominated olive oil, chlorinated peanut oil, brominated peanut oil, chlorinated sunflower oil, brominated sunflower oil, and the like. Halogenated vegetable oils may not have the needed physical properties such as density and/or viscosity, so it is recommended and preferred to use halogenated vegetable oils in mixtures with other halogen-containing compounds.

Halogenated natural products in the practice of this invention include partially or fully halogenated natural products in which all of the halogen atoms are either chlorine or bromine, or the halogen atoms are a mixture of any two or more halogen atoms when at least one of the halogen atoms is chlorine or bromine. Halogenated natural products in which all of the halogen atoms are bromine or chlorine, or in which the halogen atoms are chlorine atoms and bromine atoms, are preferred.

Suitable halogenated natural products include chlorinated farnesenes (sesquiterpenes), brominated farnesenes, chlorinated myrcene (monoterpene), brominated myrcene, chlorinated geraniol, brominated geraniol, chlorinated geranyl acetate, brominated geranyl acetate, chlorinated squalene (diterpene), brominated squalene, chlorinated carotene (tetraterpene), brominated carotene, chlorinated limonene, brominated limonene, chlorinated vitamin A, brominated vitamin A, glucose pentakis (trichloro acetate), glucose pentakis (tribromoacetate), chlorinated graphene, brominated graphene, chlorinated graphite, brominated graphite, and the like.

Halogenated fatty acids and halogenated fatty acid esters in the practice of this invention include partially or fully halogenated fatty acids in which all of the halogen atoms are either chlorine or bromine, or the halogen atoms are a mixture of any two or more halogen atoms when at least one of the halogen atoms is chlorine or bromine Halogenated fatty acids and halogenated fatty acid esters in which all of the halogen atoms are bromine or chlorine, or in which the halogen atoms are chlorine atoms and bromine atoms, are preferred.

Suitable halogenated fatty acids include dichlorooctadecanoic acid, dibromooctadecanoic acid, tetrachlorooctadecanoic acid, tetrabromooctadecanoic acid, hexachlorooctadecanoic acid, hexabromooctadecanoic acid, and the like.

Suitable halogenated fatty acid esters include transesterified chlorinated vegetable oils, such as methyl dichlorooctadecanoate, ethyl dichlorooctadecanoate, methyl tetrachlorooctadecanoate, methyl hexachlorooctadecanoate, trichloroneopentyl hexachlorooctadecanoate, and chloroethyl hexachlorooctadecanoate, transesterified brominated vegetable oils, such as methyl dibromooctadecanoate, ethyl dibromooctadecanoate, methyl tetrabromooctadecanoate, methyl hexabromooctadecanoate, tribromoneopentyl hexabromooctadecanoate, and bromoethyl hexabromooctadecanoate, chlorinated fatty acid allyl esters, brominated fatty acid allyl esters, and the like.

Halogen-containing oligomers and halogen-containing polymers in the practice of this invention include partially or fully halogenated oligomers and polymers in which all of the halogen atoms are either chlorine or bromine, or the halogen atoms are a mixture of any two or more halogen atoms when at least one of the halogen atoms is chlorine or bromine Halogen-containing oligomers and halogen-containing polymers in which all of the halogen atoms are bromine or chlorine, or in which the halogen atoms are chlorine atoms and bromine atoms, are preferred.

Some of the halogen-containing oligomers and halogen-containing polymers are liquids, while others are solids, with some variation depending on factors such as the chain length of the oligomer or polymer, and the amount of halogen present in the oligomer or polymer.

Suitable halogen-containing oligomers and halogen-containing polymers include chlorinated synthetic rubbers, brominated synthetic rubbers, chlorinated polybutadiene, brominated polybutadiene, chlorinated polycyclopentadiene, brominated polycyclopentadiene, chlorinated polystyrenes, brominated polystyrenes (Albemarle Corporation), and the like.

Suitable chlorine-containing aromatic compounds include chlorobenzene, 1,2-dichlorobenzene, 1,3-dichlorobenzene, 1,4-dichlorobenzene, 1,2,3-trichlorobenzene, 1,2,4-trichlorobenzene, 1,3,5-trichlorobenzene, 1,2,3,4-tetrachlorobenzene, 1,2,4,5-tetrachlorobenzene, 1,2,3,5-tetrachlorobenzene, pentachlorobenzene, hexachlorobenzene, 4-chlorobiphenyl, 1-chloronaphthalene, 2-chloronaphthalene, 2-chlorotoluene, 3-chlorotoluene, 4-chlorotoluene, 2,4-dichlorotoluene, 2,5-dichlorotoluene, 3,4-dichlorotoluene, 3,5-dichlorotoluene, 3-chloro-o-xylene, 4-chloro-o-xylene, 2-chloro-m-xylene, 4-chloro-m-xylene, 5-chloro-m-xylene, 2-chloro-p-xylene, (2-chloroethyl) benzene, 4,6-dichloro-o-xylene, 2,5-dichloro-m-xylene, 2,5-dichloro-p-xylene, 2,4,5-trichlorotoluene, 2,4,6-trichlorotoluene, 1-chloro-2-ethylbenzene, 1-chloro-3-ethylbenzene, 1-chloro-4-ethylbenzene, 2,4-dichloro-1-ethylbenzene, 1,3-dichloro-2-ethylbenzene, 1,4-dichloro-2-ethylbenzene, 1,3-dichloro-5-ethylbenzene, 1,2-dichloro-4-ethylbenzene, 1,3,5-trichloro-2-ethylbenzene, 1,2,3-trichloro-4-ethylbenzene, 1,2,3-trichloro-5-ethylbenzene, 1,2,4-trichloro-3-ethylbenzene, 1,2,3,5-tetrachloro-4-ethylbenzene, 1,2,3,4-tetrachloro-5-ethylbenzene, 1,2,4,5-trichloro-3-ethylbenzene, 1,2,3,4,5-pentachloro-6-ethylbenzene, 1-chloro-2-isopropylbenzene, 1-chloro-3-isopropylbenzene, 1-chloro-4-isopropylbenzene, 2,4-dichloro-1-isopropylbenzene, 1,3-dichloro-2-isopropylbenzene, 1,4-dichloro-2-isopropylbenzene, 1,3-dichloro-5-isopropylbenzene, 1,2-dichloro-4-isopropylbenzene, 1,3,5-trichloro-2-isopropylbenzene, 1,2,3-trichloro-4-isopropylbenzene, 1,2,3-trichloro-5-isopropylbenzene, 1,2,4-trichloro-3-isopropylbenzene, 1,2,3,5-tetrachloro-4-isopropylbenzene, 1,2,3,4-tetrachloro-5-isopropylbenzene, 1,2,4,5-trichloro-3-isopropylbenzene, 1,2,3,4,5-pentachloro-6-isopropylbenzene, 2-chloroanisole, 3-chloroanisole, 4-chloroanisole, 2,4,6-trichloroanisole, 2-chlorofuran, 3-chlorofuran, 2,5-dichlorofuran, 2,4-dichlorofuran, 3,4-dichlorofuran, 2,3-dichlorofuran, 2,3,5-trichlorofuran, 2,3,4-trichlorofuran, tetrachlorofuran, 2-chlorothiophene, 3-chlorothiophene, 2,5-dichlorothiophene, 3,4-dichlorothiophene, 2,4-dichlorothiophene, 2,3-dichlorothiophene, 2,3,5-trichlorothiophene, 2,3,4-trichlorothiophene, tetrachlorothiophene, 2-chloro-N-methylpyrrole, 3-chloro-N-methylpyrrole, 2,5-dichloro-N-methylpyrrole, 2,4-dichloro-N-methylpyrrole, 3,4-dichloro-N-methylpyrrole, 2,3-dichloro-N-methylpyrrole, 2,3,5-trichloro-N-methylpyrrole, 2,3,4-trichloro-N-methylpyrrole, tetrachloro-N-methylpyrrole, 2-chloro-N-ethylpyrrole, 3-chloro-N-ethylpyrrole, 2,5-dichloro-N-ethylpyrrole, 2,4-dichloro-N-ethylpyrrole, 3,4-dichloro-N-ethylpyrrole, 2,3-dichloro-N-ethylpyrrole, 2,3,5-trichloro-N-ethylpyrrole, 2,3,4-trichloro-N-ethylpyrrole, tetrachloro-N-ethylpyrrole, 2-chloropyridine, 3-chloropyridine, 4-chloropyridine, 2,6-dichloropyridine, 2,4-dichloropyridine, 2,5-dichloropyridine, 2,3-dichloropyridine, 3,4-dichloropyridine, 3,5-dichloropyridine, 2,4,6-trichloropyridine, 2,3,5-trichloropyridine, 3,4,5-trichloropyridine, 2,3,6-trichloropyridine, 2,3,4-trichloropyridine, 2,3,5,6-tetrachloropyridine, 2,3,4,5-tetrachloropyridine, pentachloropyridine, 2,4,6-trichlorophenol, tetrachlorobisphenol A, decachlorodiphenyl oxide, tetradecachlorodiphenoxybenzene, 1,2-bis(pentachlorophenyl) ethane, 2,4,6-tris(2,3-dichloropropoxy)-1,3,5-triazine, ethylene bis(tetrachlorophthalimide), dimethyl tetrachlorophthalate, bis(2,3-dichloropropyl) phthalate, bis(2-ethylhexyl) tetrachlorophthalate, tetrachlorophthalic anhydride, (2-hydroxypropyl)[(2-hydroxyethoxy)ethyl] tetrachlorophthalate, and the like.

The halogen-containing aromatic compounds can be homocyclic or heterocyclic, and include fused-ring aromatic compounds. These halogen-containing aromatic compounds may have groups attached to the aromatic ring, such as hydrocarbyl, hydrocarbyloxy, amino, hydroxyl, and the like. Halogen atoms can be present on the rings and/or on the substituent group(s); preferably, one or more halogen atoms are on the aromatic ring. In some embodiments, bromine-containing aromatic compounds are preferred. In other embodiments, bromine-containing homocyclic aromatic compounds are preferred. In still other embodiments, bromine-containing heterocyclic aromatic compounds are preferred.

Suitable bromine-containing aromatic organic compounds include bromobenzene, 1,2-dibromobenzene, 1,3-dibromobenzene, 1,4-dibromobenzene, 1,2,3-tribromobenzene, 1,2,4-tribromobenzene, 1,3,5-tribromobenzene, 1,2,3,4-tetrabromobenzene, 1,2,4,5-tetrabromobenzene, 1,2,3,5-tetrabromobenzene, pentabromobenzene, hexabromobenzene, 4-bromobiphenyl, 1-bromonaphthalene, 2-bromonaphthalene, 2-bromotoluene, 3-bromotoluene, 4-bromotoluene, 2,4-dibromotoluene, 2,5-dibromotoluene, 3,4-dibromotoluene, 3,5-dibromotoluene, 3-bromo-o-xylene, 4-bromo-o-xylene, 2-bromo-m-xylene, 4-bromo-m-xylene, 5-bromo-m-xylene, 2-bromo-p-xylene, (2-bromoethyl) benzene, 4,6-dibromo-o-xylene, 2,5-dibromo-m-xylene, 2,5-dibromo-p-xylene, 2,4,5-tribromotoluene, 2,4,6-tribromotoluene, 1-bromo-2-ethylbenzene, 1-bromo-3-ethylbenzene, 1-bromo-4-ethylbenzene, 2,4-dibromo-1-ethylbenzene, 1,3-dibromo-2-ethylbenzene, 1,4-dibromo-2-ethylbenzene, 1,3-dibromo-5-ethylbenzene, 1,2-dicbromo-4-ethylbenzene, 1,3,5-tribromo-2-ethylbenzene, 1,2,3-tribromo-4-ethylbenzene, 1,2,3-tribromo-5-ethylbenzene, 1,2,4-tribromo-3-ethylbenzene, 1,2,3,5-tetrabromo-4-ethylbenzene, 1,2,3,4-tetrabromo-5-ethylbenzene, 1,2,4,5-tribromo-3-ethylbenzene, 1,2,3,4,5-pentabromo-6-ethylbenzene, 1-bromo-2-isopropylbenzene, 1-bromo-3-isopropylbenzene, 1-bromo-4-isopropylbenzene, 2,4-dibromo-1-isopropylbenzene, 1,3-dibromo-2-isopropylbenzene, 1,4-dibromo-2-isopropylbenzene, 1,3-dibromo-5-isopropylbenzene, 1,2-dibromo-4-isopropylbenzene, 1,3,5-tribromo-2-isopropylbenzene, 1,2,3-tribromo-4-isopropylbenzene, 1,2,3-tribromo-5-isopropylbenzene, 1,2,4-tribromo-3-isopropylbenzene, 1,2,3,5-tetrabromo-4-isopropylbenzene, 1,2,3,4-tetrabromo-5-isopropylbenzene, 1,2,4,5-tribromo-3-isopropylbenzene, 1,2,3,4,5-pentabromo-6-isopropylbenzene, 2-bromoanisole, 3-bromoanisole, 4-bromoanisole, 2,4,6-tribromoanisole, 2-bromofuran, 3-bromofuran, 2,5-dibromofuran, 2,4-dibromofuran, 3,4-dibromofuran, 2,3-dibromofuran, 2,3,5-tribromofuran, 2,3,4-tribromofuran, tetrabromofuran, 2-bromothiophene, 3-bromothiophene, 2,5-dibromothiophene, 3,4-dibromothiophene, 2,4-dibromothiophene, 2,3-dibromothiophene, 2,3,5-tribromothiophene, 2,3,4-tribromothiophene, tetrabromothiophene, 2-bromo-N-methylpyrrole, 3-bromo-N-methylpyrrole, 2,5-dibromo-N-methylpyrrole, 2,4-dibromo-N-methylpyrrole, 3,4-dibromo-N-methylpyrrole, 2,3-dibromo-N-methylpyrrole, 2,3,5-tribromo-N-methylpyrrole, 2,3,4-tribromo-N-methylpyrrole, tetrabromo-N-methylpyrrole, 2-bromo-N-ethylpyrrole, 3-bromo-N-ethylpyrrole, 2,5-dibromo-N-ethylpyrrole, 2,4-dibromo-N-ethylpyrrole, 3,4-dibromo-N-ethylpyrrole, 2,3-dibromo-N-ethylpyrrole, 2,3,5-tribromo-N-ethylpyrrole, 2,3,4-tribromo-N-ethylpyrrole, tetrabromo-N-ethylpyrrole, 2-bromopyridine, 3-bromopyridine, 4-bromopyridine, 2,6-dibromopyridine, 2,4-dibromopyridine, 2,5-dibromopyridine, 2,3-dibromopyridine, 3,4-dibromopyridine, 3,5-dibromopyridine, 2,4,6-tribromopyridine, 2,3,5-tribromopyridine, 3,4,5-tribromopyridine, 2,3,6-tribromopyridine, 2,3,4-tribromopyridine, 2,3,5,6-tetrabromopyridine, 2,3,4,5-tetrabromopyridine, pentabromopyridine, 2,4,6-tribromophenol, tetrabromobisphenol A, decabromodiphenyl oxide, tetradecabromodiphenoxybenzene, 1,2-bis(pentabromophenyl) ethane, 2,4,6-tris(2,3-dibromopropoxy)-1,3,5-triazine, ethylene bis(tetrabromophthalimide), dimethyl tetrabromophthalate, bis(2,3-dibromopropyl) phthalate, bis(2-ethylhexyl)tetrabromophthalate (Uniplex® FRP-45, Unitex Chemical Corporation), tetrabromophthalic anhydride, (2-hydroxypropyl)[(2-hydroxyethoxylethyl]tetrabromophthalate (Saytex® RB-79, Albemarle Corporation), and the like. Preferred bromine-containing homocyclic aromatic compounds include dibromobenzenes, tribromobenzenes, and mixtures thereof, especially mixtures comprising one or more dibromobenzenes and one or more tribromobenzenes. Preferred dibromobenzenes include 1,3-dibromobenzene. Preferred bromine-containing heterocyclic aromatic compounds include 2,5-dibromothiophene.

Suitable iodine-containing aromatic compounds include iodobenzene, 1,2-diiodobenzene, 1,3-diiodobenzene, 1,4-diiodobenzene, 2-iodotoluene, 3-iodotoluene, 4-iodotoluene, 3-iodo-o-xylene, 4-iodo-m-xylene, 2-iodo-m-xylene, 2,5-diiodo-p-xylene, 1-ethyl-2-iodobenzene, 1-ethyl-3-iodobenzene, 1-ethyl-4-iodobenzene, 1-ethyl-2,4-diiodobenzene, 1-isopropyl-2-iodobenzene, 1-isopropyl-3-iodobenzene, 1-isopropyl-4-iodobenzene, 1-isopropyl-2,4-diiodobenzene, 3-iodophenol, 3-iodoanisole, 1-iodonaphthalene, 2-iodonaphthalene, 2-iodofluorene, 2,7-diiodofluorene, 2-iodofuran, 3-iodofuran, 2,5-diiodofuran, 3,4-diiodofuran, 3,4-diiodofuran, 2,4-diiodofuran, 2,3-diiodofuran, 2-iodothiophene, 3-iodothiophene, 2,5-diiodothiophene, 3,4-diiodothiophene, 3,4-diiodothiophene, 2,4-diiodothiophene, 2,3-diiodothiophene, 2-iodo-N-methylpyrrole, 3-iodo-N-methylpyrrole, 2,5-diiodo-N-methylpyrrole, 2,4-diiodo-N-methylpyrrole, 3,4-diiodo-N-methylpyrrole, 2,3-diiodo-N-methylpyrrole, 2-iodopyridine, 3-iodopyridine, 4-iodopyridine, 2,6-diiodopyridine, 2,4-diiodopyridine, 2,4-diiodopyridine, 2,5-diiodopyridine, 2,3-diiodopyridine, 3,4-diiodopyridine, 3,5-diiodopyridine, and the like.

Suitable mixed halogen-containing aromatic organic compounds include 1-bromo-2-chlorobenzene, 1-bromo-3-chlorobenzene, 1-bromo-4-chlorobenzene, 1-bromo-4-fluorobenzene, 4-bromo-1,2-dichlorobenzene, 2-bromobenzotrifluoride, 3-bromobenzotrifluoride, 4-bromobenzotrifluoride, 2-bromo-3-chlorobenzotrifluoride, 2-bromo-5-chlorobenzotrifluoride, 3-bromo-4-chlorobenzotrifluoride, 3-bromo-5-chlorobenzotrifluoride, 4-bromo-2-chlorobenzotrifluoride, 4-bromo-3-chlorobenzotrifluoride, 2,4-bis(trifluoromethyl)-1-bromobenzene, 2,5-bis(trifluoromethyl)-1-bromobenzene, 3,5-bis(trifluoromethyl)bromobenzene, 1-bromo-2-chloro-4-fluorobenzene, 1-bromo-3-chloro-2-fluorobenzene, 1-bromo-3-chloro-4-fluorobenzene, 1-bromo-3-chloro-5-fluorobenzene, 1-bromo-4-chloro-2-fluorobenzene, 1-bromo-4-chloro-3-fluorobenzene, 2-bromo-1-chloro-4-fluorobenzene, 2-bromo-4-chloro-1-fluorobenzene, 4-bromo-1-chloro-2-fluorobenzene, 4-bromo-2-chloro-1-fluorobenzene, 4-bromo-3-chloro-1-fluorobenzene, 5-bromo-2-chloro-1,3-difluorobenzene, 1,3-dibromo-5-fluorobenzene, 1,4-dibromo-2-fluorobenzene, 2,4-dibromo-1-fluorobenzene, 1-bromo-5-chloro-3-fluoro-2-iodobenzene, 2-bromo-3-chlorotoluene, 2-bromo-4-chlorotoluene, 2-bromo-5-chlorotoluene, 2-bromo-6-chlorotoluene, 3-bromo-2-chlorotoluene, 3-bromo-4-chlorotoluene, 3-bromo-5-chlorotoluene, 4-bromo-2-chlorotoluene, 4-bromo-3-chlorotoluene, 5-bromo-2-chlorotoluene, 3-bromo-2-chloro-5-fluorotoluene, 3-bromo-4-chloro-5-fluorotoluene, 3-bromo-6-chloro-2-fluorotoluene, 4-bromo-5-chloro-2-fluorotoluene, 5-bromo-2-chloro-4-fluorotoluene, 5-bromo-4-chloro-2-fluorotoluene, 4-bromo-2-chloro-1-iodobenzene, 2-bromo-5-chlorofuran, 2-bromo-5-iodofuran, 2-bromo-5-fluorofuran, 2-bromo-5-chlorothiophene, 2-bromo-5-iodothiophene, 2-bromo-5-fluorothiophene, 2-bromo-5-chloro-N-methylpyrrole, 2-bromo-5-iodo-N-methylpyrrole, 2-bromo-5-fluoro-N-methylpyrrole, 2-bromo-3-chloropyridine, 2-bromo-3-iodopyridine, 2-bromo-3-fluoropyridine, 2-bromo-4-chloropyridine, 2-bromo-4-iodopyridine, 2-bromo-4-fluoropyridine, 2-bromo-5-chloropyridine, 2-bromo-5-iodopyridine, 2-bromo-5-fluoropyridine, 2-bromo-6-chloropyridine, 2-bromo-6-iodopyridine, 2-bromo-6-fluropyridine, 3-bromo-4-chloropyridine, 3-bromo-4-iodopyridine, 3-bromo-4-fluoropyridine, 3-bromo-5-chloropyridine, 3-bromo-5-iodopyridine, 3-bromo-5-fluoropyridine, and the like. Preferred mixed-halogen compounds are those containing both bromine and chlorine.

The halogen-containing nonaromatic organic compounds can be straight-chain, branched, or cyclic, and may contain heteroatoms. Cyclic halogen-containing groups may have groups attached to the ring such as hydrocarbyl, hydrocarbyloxy, amino, hydroxyl, and the like. Similarly, straight-chain and branched halogen-containing nonaromatic compounds may contain groups such as hydrocarbyl, hydrocarbyloxy, amino, hydroxyl, and the like. In some embodiments, bromine-containing nonaromatic organic compounds are preferred. In other embodiments, bromine-containing straight-chain compounds are preferred.

Suitable chlorine-containing nonaromatic organic compounds include dichloromethane, trichoromethane (chloroform), carbon tetrachloride, 1,2-dichloroethylene, 1,1,2-trichloroethylene, tetrachloroethylene, chloroethane, 1,2-dichloroethane, 1,1,1-trichloroethane, 1,1,2-trichloroethane, 1,1,2,2-tetrachloroethane, pentachloroethane, hexachloroethane, 1,2-dichloropropane, 1,3-dichloropropane, 1,1,2-trichloropropane, 1,2,2-trichloropropane, 1,2,3-trichloropropane, 1,1,2,2,3-pentachloro-n-propane, 1,2-dichlorobutane, 1,4-dichlorobutane, 1,2,2-trichlorobutane, 1,2,3-trichlorobutane, 2,2,3-trichlorobutane, 1,2,3,4-tetrachlorobutane, 1,2-dichloro-2-methylpropane, hexachlorobutadiene, trichloroneopentane, 1-chlorocyclopropene, 1-chlorocyclobutene, 1-chlorocyclopentene, 1,2-dichlorocyclopentene, 1-chlorocyclohexene, 1,2-dichlorocyclohexene, 1-chlorocycloheptene, 1,2-dichlorocycloheptene, 1-chlorocyclooctene, 1,2-dichlorocyclooctene, 1-chloro-4-(1-chloroethenyl)-cyclohexene, hexachlorocyclododecane, 2,2,2-trichloroethanol, 1,1,3,3-tetrachloropropan-2-ol, 2,2,3,3-tetrachloropropan-1-ol, 2,3,4-trichloro-tert-butanol, pentaerithritol trichloride, pentaerithritol tetrachloride, 2,2,2-trichloro-1,1-ethanediol, bis(2,3-dichloropropyl) ether, bis(trichloroneopentyl) ether, trichloroneopentyl glycidyl ether, trichloroneopentyl acrylate, trichloroacetaldehyde, 1,1,3,3,-tetrachloroacetone, hexachloroacetone, methyl trichloroacetate, 2,2,2-trichloroethyl trichloroacetate, 2,3-dichloropropyl trichloroacetate, 2,2,3,3-tetrachloropropyl acetate, 2,3-dichloropropyl-α,β-dichloropropionate, methyl 2,2,3,3-tetrachloropropyl carbonate, bis(2,3-dichloropropyl) carbonate, trichloro acetic acid, diethyl 2,3-dichloromaleate, bis(2,3-dichloropropyl) 2,3-dichlorosuccinate, N,N-bis(2,3-dichloropropyl) acetamide, 2,4,6-tris(2,3-dichloropropoxy) isocyanurate, bis(trichloromethyl) sulfone, di(chloromethyl) sulfoxide, bis(trichloromethyl) sulfoxide, and the like.

Suitable bromine-containing nonaromatic organic compounds include dibromomethane, tribromomethane, tetrabromomethane, 1,2,3,4-tetrabromo-2-methylbutane, 1,2-dibromoethylene, 1,1,2-tribromoethylene, tetrabromoethylene, bromoethane, 1,2-dibromoethane, 1,1,2-tribromoethane, 1,1,2,2-tetrabromoethane, pentabromoethane, hexabromoethane, 1,2-dibromopropane, 1,3-dibromopropane, 1,1,2-tribromopropane, 1,2,2-tribromopropane, 1,2,3-tribromopropane, 1,1,2,2,3-pentabromo-n-propane, 1,2-dibromobutane, 1,4-dibromobutane, 1,2,2-tribromobutane, 1,2,3-tribromobutane, 2,2,3-tribromobutane, 1,2,3,4-tetrabromobutane, 1,2-dibromo-2-methylpropane tribromoneopentane, 1-bromocyclopropene, 1-bromocyclobutene, 1-bromocyclopentene, 1,2-dibromocyclopentene, 1-bromocyclohexene, 1,2-dibromocyclohexene, 1-bromocycloheptene, 1,2-dibromocycloheptene, 1-bromocyclooctene, 1,2-dibromocyclooctene, 1-bromo-4-(1-bromoethenyl)-cyclohexene, hexabromocyclododecane, 2,2,2-tribromoethanol, 1,1,3,3-tetrabromopropan-2-ol, 2,2,3,3-tetrabromopropan-1-ol, 2,3,4-tribromo-tert-butanol, pentaerithritol tribromide, pentaerithritol tetrabromide, 2,2,2-tribromo-1,1-ethanediol, bis(2,3-dibromopropyl) ether, hexabromoneopentyl ether, tribromoneopentyl glycidyl ether, tribromoneopentyl acrylate, tribromoacetaldehyde, 1,1,3,3,-tetrabromoacetone, hexabromoacetone, methyl tribromoacetate, 2,2,2-tribromoethyl tribromoacetate, 2,3-dibromopropyl tribromoacetate, 2,2,3,3-tetrabromopropyl acetate, 2,3-dibromopropyl-α,β-dibromopropionate, methyl 2,2,3,3-tetrabromopropyl carbonate, bis(2,3-dibromopropyl) carbonate, tribromo acetic acid, diethyl 2,3-dibromomaleate, bis(2,3-dibromopropyl) 2,3-dibromosuccinate, N,N-bis(2,3-dibromopropyl) acetamide, 2,4,6-tris(2,3-dibromopropoxy) isocyanurate, bis(tribromomethyl) sulfone, di(bromomethyl) sulfoxide, bis(tribromomethyl) sulfoxide, and the like. Preferred bromine-containing nonaromatic organic compounds include 1,1,2-tribromoethylene.

Suitable mixed halogen-containing nonaromatic organic compounds include bromochloromethane, bromodichloromethane, dibromochloromethane, bromotrichloromethane, tribromofluoromethane, tribromochloromethane, bromochloroiodomethane, dichloroiodomethane, dibromoiodomethane, chlorodiiodomethane, bromodiiodomethane, dibromodichloromethane, 1-bromo-2-chloroethane, 1-bromo-2-chloropropane, 2-bromo-1-chloropropane, 1-bromo-3-chloropropane, 1-bromo-3-chloro2-methyl-propane, 1,2-dibromo-1-iodo-ethylene, 1,2-dibromo-3-chloropropane, 1,2-dibromo-1,1-dichloroethane, 1,2-dibromo-1,2-dichloroethane, 1,2-dibromo-1,1,2-trichloroethane, 2,3-dibromo-1,4-dichlorobutane, 3,4-dibromo-2-chloro-1-butene, 1-bromo-1,1,2,2-tetrachloro-2-fluoroethane, 1-bromo-2,2,2-trichloro-1,1-difluoroethane, 1,2-dibromo-1-chloro-1,2,2-trifluoroethane, 1,1,1-tribromo-2,2,2-trifluoroethane, 1,1,1-tribromo-2,2,2-trichloroethane, 1,1-dibromo-2-chloro-1,2-difluorethane, 1,3-dibromo-1,1,3,3-tetrachloro-2,2-difluoropropane, 1-bromo-2-chlorocyclopentene, 1-bromo-2-iodocyclopentene, 1-bromo-2-chlorocyclohexene, 1-bromo-2-iodocyclohexene, 1-bromo-2-fluorocyclohexene, and the like.

Halogenated ionic compounds in the practice of this invention include salts of partially or fully halogenated fatty acids, in which the halogen atoms are as described above for the halogenated fatty acids. Some of the salts are metal salts, which have metal counterions, and some of the salts have counterions which are halogen-containing quaternary cations (some of these compounds are ionic liquids). The metal salts of the halogenated fatty acids, and some of the halogenated fatty acid salts with halogen-containing quaternary cations may be solids, and if so, need to mixed with another component to be in liquid form.

The metal counterions for the halogenated fatty acid metal salts are preferably polyvalent (in the sense of having a formal oxidation state greater than +1). Also preferred are metal counterions that are heavier relative to other metal counterions. Suitable metal counterions include, but are not limited to, sodium, potassium, magnesium, calcium, barium, titanium, manganese, cobalt, nickel, iron, zinc, copper, and bismuth. Preferred metal counterions include iron, zinc, and bismuth.

For the halogenated fatty acid salts that have halogen-containing quaternary cations as counterions, all of the halogen atoms are either chlorine or bromine, or the halogen atoms are a mixture of any two or more halogen atoms when at least one of the halogen atoms is chlorine or bromine Halogen-containing quaternary cations in which all of the halogen atoms are bromine or chlorine, or in which the halogen atoms are chlorine atoms and bromine atoms, are preferred.

Suitable halogen-containing quaternary cations include tetrakis(2,3-dichloropropyl) ammonium, tetrakis(2,3-dibromopropyl) ammonium, tris(2,3-dichloropropyl) methyl ammonium, tris(2,3-dibromopropyl) methyl ammonium, tetrakis(2,3-dichloropropyl) phosphonium, tetrakis(2,3-dibromopropyl) phosphonium, and the like. Examples of suitable halogenated fatty acid salts in which the counterion is a halogen-containing quaternary cation include, but are not limited to, tetrakis(2,3-dichloropropyl) ammonium dichlorooctadecanoate, tetrakis(2,3-dibromopropyl) ammonium dibromooctadecaanoate, tris(2,3-dichloropropyl) methylammonium tetrachlorooctadecanoate, and tris(2,3-dibromopropyl) methylammonium tetrabromooctadecanoate.

Optionally, one or more physical weighting agents can be included in the kill fluid to increase the density of the kill fluid. Typical weighting agents include clays and other solid inorganic materials. Suitable weighting agents include, but are not limited to, bentonite, barite (BaSO₄), hematite (Fe₂O₃), magnetite (Fe₃O₄), siderite (FeCO₃), ilmenite (FeTiO₃), carbonates of magnesium and calcium (MgCO₃ and CaCO₃), sodium chloride (NaCl), zinc oxide (ZnO), zirconium oxide (ZrO₂), and manganese tetraoxide (Mn₃O₄). The weighting agents are generally in the form of fine powders so that suspensions in the fluid can be easily formed.

Other components that may optionally be present in the kill fluid include hydrocarbons, e.g., pentane, cyclopentane, hexane, cyclohexane, methylcyclohexane, heptane, octane, cyclooctane, nonane, and the like; non-halogenated, water-immiscible ethers, e.g., diethyl ether, methyl tert-butyl ether, di-iso-propyl ether, cyclopentyl methyl ether, and the like; stabilizers such as corrosion inhibitors, oxygen scavengers, antioxidants, acid scavengers, e.g. epoxides, and the like.

The following examples are presented for purposes of illustration, and are not intended to impose limitations on the scope of this invention.

### EXAMPLE 1

Bromine-containing fluids were tested for reduction of sustained casing pressure in an 0.8 inch (2.03 cm) inner diameter glass column filled with a clear completion fluid (CCF; aqueous CaBr₂). Two kill fluids were prepared. Kill fluid A was a mixture containing 75 wt % 1,1,2-tribromoethane (TBE) and 25 wt % brominated vegetable oil (BVO; 20 wt % bromine); kill fluid B was a mixture containing 72 wt % TBE and 28 wt % BVO (20 wt % bromine). Both kill fluids were formed by stirring the two components together for several minutes.

In each run, one of the kill fluids was dropped from a separatory funnel into the filled column. The time for the kill fluid to drop one foot (30 cm) was recorded. Results are summarized in Table 1. Smaller droplets were observed to move considerably more slowly than larger droplets.

TABLE 1

| | Density | | |
|---|---|---|---|
| Kill fluid | Kill fluid^{a} | CCF^{a} | Time for 1 foot (0.3 m) drop^{b} |
| A | 16.1 ppg | 14.2 ppg | 4.4 s (avg.) |
| | (1.93 kg/L) | (1.70 kg/L) | |
| A | 16.1 ppg | 15.0 ppg | 6.7 s (avg.) |
| | (1.86 kg/L) | (1.80 kg/L) | |
| B | 15.5 ppg | 15.0 ppg | 12.1 s (avg.) |
| | (1.86 kg/L) | (1.80 kg/L) | |

^{a}The abbreviation “ppg” stands for pounds per gallon.
^{b}Number reported is an average of 3 droplets in a single run.

### EXAMPLE 2

Brominated kill fluids were tested in an 0.8 inch (2.03 cm; I.D.) glass column filled with water-based drilling fluids (containing bentonite and barium sulfate). Two kill fluids were prepared. Kill fluid C was a mixture containing 68 wt % 1,1,2-tribromoethane and 32 wt % brominated fatty acid methyl esters of C₁₈ fatty acids (36 wt % bromine); kill fluid D was a mixture containing 70 wt % 1,1,2-tribromoethane and 30 wt % 1,3-dibromopropane. Both of the kill fluids were formed by stiffing the two components together for several minutes.

In each run, one of the kill fluids was dropped from a separatory funnel into the filled column The initial test of kill fluid C (density of 16 ppg) in drilling mud (density of 14.5 ppg), a density difference of 1.5 ppg, was unsuccessful. The kill fluid stayed about 2 inches (5.1 cm) below the surface of the drilling fluid, and kill fluid C did not move with tapping of the column. The second test was with kill fluid D (density 20 ppg) in drilling mud (density of 10.5 ppg), a density difference of 9.5 ppg (1.14 kg/L); this kill fluid also stayed at about 2 inches (5.1 cm) below the surface of the drilling fluid. Kill fluid D did settle quickly to the bottom of the column when a small amount of nitrogen was bubbled through the bottom of the column. It is believed that in an actual well, releasing the pressure (by venting) will cause gases to rise from the bottom of the well, and these gases may create enough disturbance to cause the kill fluid to move downward.

TABLE 2

| Kill | Density | | |
|---|---|---|---|
| fluid | Kill fluid^{a} | Drilling fluid^{a} | Result |
| C^{b} | 16 ppg (1.91 kg/L) | 14.5 ppg (1.74 kg/L) | stayed 2 inches below surface; no |
| | | | change with tapping |
| D | 20 ppg (2.40 kg/L) | 10.5 ppg (1.26 kg/L) | stayed 2 inches below surface; |
| | | | settled to bottom with N₂ bubbling |

^{a}The abbreviation “ppg” stands for pounds per gallon.
^{b}Comparative run.

The above results were obtained in a column filled with drilling fluid, not an annulus. Different results were observed in experiments run in an annulus (see Examples 3-7).

### EXAMPLE 3

Brominated kill fluids were tested in a 3 foot (0.9 m) tall polycarbonate column with a 4-inch (10.16 cm) outer diameter and a 1-inch (2.54 cm) annular space (annulus). The column annulus was filled with a water-based drilling fluid (containing bentonite and barium sulfate; 3.4 L; density: 10.5 ppg). One kill fluid was prepared. Kill fluid E was a mixture containing 50 wt % brominated vegetable oil (38 wt % bromine) and 50 wt % of a brominated acetone mixture (86 wt % bromine) The kill fluid was formed by stirring the two components together for several minutes.

In each run, the kill fluid was dropped from a separatory funnel into the filled column annulus. After the kill fluid settled at the bottom of the column, it was recovered by draining it through the bottom of the annulus, and the kill fluid was weighed. This weight was compared to the weight of kill fluid added to determine the recovery. Kill fluid E had a recovery of about 83% for the first run, even though most of the kill fluid settled to the bottom. A dead volume of about 40 mL in the column due to the location of the drain valve may be responsible for the recovery yield being lower than expected for successful settling. A second run with kill fluid E was also successful, providing about 97.5% recovery of the kill fluid.

The drilling mud was left in the column to settle for 4 hours before the third run was conducted. Kill fluid E stayed at the top of column for about a minute, and then sank to the bottom of the column. Recovery of kill fluid E for this run was 92.5%.

TABLE 3

| | Density | | | Recovery of |
|---|---|---|---|---|
| Kill fluid | Kill fluid^{a} | Drilling fluid^{a} | Result | kill fluid |
| E | 14.6 ppg (1.75 kg/L) | 10.5 ppg (1.26 kg/L) | settled on bottom | 83% |
| E | 14.6 ppg (1.75 kg/L) | 10.5 ppg (1.26 kg/L) | settled on bottom | 97.5% |
| E | 14.6 ppg (1.75 kg/L) | 10.5 ppg (1.26 kg/L) | settled on bottom | 92.5% |

^{a}The abbreviation “ppg” stands for pounds per gallon.

Higher recovery yields indicate more efficient settling of the kill fluid, and confirm that the kill fluid is heavier than, and immiscible with, the water-based drilling fluid.

### EXAMPLE 4

Brominated and chlorinated kill fluids were tested in a 3 foot (0.9 m) tall glass column with a 1 inch (2.54 cm) annulus. The annulus had a 5 L capacity, and was filled with 3.8 L of water-based drilling muds containing bentonite and barium sulfate. The drilling mud was allowed to settle for 45 minutes before introducing a kill fluid into the drilling mud. The kill fluid was introduced either subsurface to the drilling mud via a funnel connected to 0.5 inch (1.25 cm) diameter tubing or above the surface of the drilling mud with a funnel not connected to tubing. Five kill fluids, all of which were mixtures, were prepared:

| | |
|---|---|
| F | dichloromethane, 93 wt %; 1,1,2,2-tetrabromoethane, 7 wt % |
| G | dichloromethane, 79 wt %; 1,1,2,2-tetrabromoethane, 21 wt % |
| H | dichloromethane, 57 wt %; 1,1,2,2-tetrabromoethane, 43 wt % |
| I | brominated oleic acid, 54.7 wt %; 1,1,2,2-tetrabromoethane, |
| | 45.3 wt % |
| J | dichloromethane, 27 wt %; 1,1,2,2-tetrabromoethane, 73 wt %. |

All of the kill fluids were formed by stirring the two components together for several minutes. The time for 500 mL of each kill fluid to settle to the bottom of the column below the drilling mud was recorded. Results are summarized in Table 4.

In this Example, the low viscosity kill fluids had viscosities less than 2 cP (0.002 Pa·s), and the medium viscosity kill fluids had viscosities between 100 and 200 cP (0.1 and 0.2 Pa·s). Subsurface and above surface addition of kill fluid gave similar settling times for low viscosity kill fluids, but subsurface addition was superior to above surface addition with medium viscosity kill fluids. An 11.5 ppg kill fluid successfully settled through 10.5 ppg drilling mud in the 1-inch (2.54 cm) annulus. In these runs, it took longer for an 18.6 ppg kill fluid to settle through a 14.5 ppg drilling mud than it took a 14.5 ppg kill fluid to settle through a 10.5 ppg drilling mud, even though the difference in density between the kill fluid and the drilling mud was the same.

TABLE 4

| | Kill fluid | Density | | Addition | Time for 2 ft. |
|---|---|---|---|---|---|
| Kill fluid | viscosity | Kill fluid^{a} | Drilling mud^{a} | Method | (0.6 m) drop |
| F | low | 11.5 ppg | 10.5 ppg | Subsurface | 300 s |
| | | (1.38 kg/L) | (1.26 kg/L) | | |
| G | low | 12.5 ppg | 10.5 ppg | Subsurface | 33 s |
| | | (1.50 kg/L) | (1.26 kg/L) | | |
| H | low | 14.5 ppg | 10.5 ppg | Subsurface | 27 s |
| | | (1.74 kg/L) | (1.26 kg/L) | | |
| H | low | 14.5 ppg | 10.5 ppg | Above | 24 s |
| | | (1.74 kg/L) | (1.26 kg/L) | surface | |
| I | medium | 14.5 ppg | 10.5 ppg | Subsurface | 128 s |
| | | (1.74 kg/L) | (1.26 kg/L) | | |
| I | medium | 14.5 ppg | 10.5 ppg | Above | 360 s |
| | | (1.74 kg/L) | (1.26 kg/L) | surface | |
| J | low | 18.6 ppg | 14.5 ppg | Subsurface | 40 s |
| | | (2.23 kg/L) | (1.74 kg/L) | | |

^{a}The abbreviation “ppg” stands for pounds per gallon.

### EXAMPLE 5

The settling velocity of several brominated and chlorinated kill fluids through drilling mud was measured in an apparatus as described in Example 4. Several kill fluids were prepared. Kill fluids F, G, H, and J are the same as in Example 4. Five additional kill fluids, all of which were mixtures, were prepared:

| | |
|---|---|
| K | brominated vegetable oil (38 wt % bromine), 94 wt %; and 1,1,2,2- |
| | tetrabromoethane, 6 wt % |
| L | brominated vegetable oil (38 wt % bromine), 90 wt %; and 1,1,2,2- |
| | tetrabromoethane, 20 wt % |
| M | brominated vegetable oil (38 wt % bromine), 58 wt %; and 1,1,2,2- |
| | tetrabromoethane, 42 wt % |
| N | dichloromethane, 48 wt %, and 1,1,2,2-tetrabromoethane, 52 wt % |
| O | dichloromethane, 40 wt %; and 1,1,2,2-tetrabromoethane, 60 wt %. |

All of the kill fluids were formed by stirring the two components together for several minutes.

All of the kill fluids (50 mL) were introduced to the annulus via subsurface addition using a funnel connected to 1 foot (0.3 m) of 0.5 inch (1.25 cm) diameter tubing.

Since the drilling mud was not transparent, the time for the kill fluid to travel through 2 feet (0.6 m) of drilling mud and exit the column through an external valve was recorded and converted to velocity. Results are summarized in Table 5.

These results show that velocity decreases as the density difference between the kill fluid and the drilling mud decreases. In this Example, the low viscosity kill fluids had viscosities of less than 2 cP (0.002 Pa·s), and the medium viscosity kill fluids had viscosities between 600 and 3060 cP (0.6 and 3.06 Pa·s). The observed velocities were higher for kill fluids with lower viscosities when settling through a drilling mud of the same density. For the same density difference between kill fluid and drilling mud, the velocity was higher when settling through lower density drilling muds.

TABLE 5

| | Kill fluid | Density | | | |
|---|---|---|---|---|---|
| Kill fluid | viscosity | Kill fluid^{a} | Drilling mud^{a} | Velocity | |
| F | low | 11.5 ppg (1.38 kg/L) | 10.5 ppg (1.26 kg/L) | 0.120 | ft/s |
| | | | | (30.66 | cm/s) |
| G | low | 12.5 ppg (1.50 kg/L) | 10.5 ppg (1.26 kg/L) | 0.285 | ft/s |
| | | | | (8.69 | cm/s) |
| H | low | 14.5 ppg (1.74 kg/L) | 10.5 ppg (1.26 kg/L) | 0.443 | ft/s |
| | | | | (13.5 | cm/s) |
| N | low | 15.5 ppg (1.86 kg/L) | 14.5 ppg (1.74 kg/L) | 0.009 | ft/s |
| | | | | (0.27 | cm/s) |
| O | low | 16.5 ppg (1.98 kg/L) | 14.5 ppg (1.74 kg/L) | 0.101 | ft/s |
| | | | | (3.08 | cm/s) |
| J | low | 18.5 ppg (2.22 kg/L) | 14.5 ppg (1.74 kg/L) | 0.398 | ft/s |
| | | | | (12.1 | cm/s) |
| K | medium | 11.5 ppg (1.38 kg/L) | 10.5 ppg (1.26 kg/L) | 0.022 | ft/s |
| | | | | (0.67 | cm/s) |
| L | medium | 12.5 ppg (1.50 kg/L) | 10.5 ppg (1.26 kg/L) | 0.104 | ft/s |
| | | | | (3.17 | cm/s) |
| M | medium | 14.5 ppg (1.74 kg/L) | 10.5 ppg (1.26 kg/L) | 0.189 | ft/s |
| | | | | (5.76 | cm/s) |

^{a}The abbreviation “ppg” stands for pounds per gallon.

### EXAMPLE 6

The effect of injecting halogenated kill fluids into drilling mud via pressure transfer at various injection rates was studied in an apparatus as described in Example 4. For each run, the annulus was filled with 4.5 L of an 8.4 ppg (1.01 kg/L) water-based drilling mud containing hydrous magnesium silicate clay (Laponite®; Rockwood Holdings, Ltd.), and the drilling mud was allowed to sit in the annulus for 45 minutes to 1 hour before the kill fluid was injected into the drilling mud. Two kill fluids were used. Kill fluid P was neat 1,1,2,2-tetrabromoethane. Kill fluid Q was a mixture of brominated vegetable oil (38 wt % bromine), 50 wt %; and 1,1,2,2-tetrabromoethane, 50 wt %, which was formed by stirring the two components together for several minutes. Nitrogen gas at pressures of 5 to 60 psi (3.4×10⁴ to 4.14×10⁵ Pa) was used to pressure-transfer each kill fluid into the drilling mud in the annulus. Kill fluid P had a viscosity less than 7 cP (0.007 Pa·s; a low viscosity), and kill fluid Q had a viscosity between 400 and 600 cP (0.4 and 0.6 Pa·s; a medium viscosity).

Each kill fluid (250 mL) was introduced to the annulus via subsurface addition using pressure transfer through 0.25-inch (cm) outer diameter (0.156-inch (cm) inner diameter) perfluoroalkoxy (PFA) tubing. After the kill fluid settled at the bottom of the column, the kill fluid was recovered by draining kill fluid through the bottom of the annulus, and the kill fluid was then weighed. This weight was compared to the weight of kill fluid added to determine the recovery of the kill fluid. Results are summarized in Table 6.

TABLE 6

| Kill | Kill fluid | Density | | | Recovery of |
|---|---|---|---|---|---|
| fluid | viscosity | Kill fluid^{a} | Drilling mud^{a} | Injection rate | kill fluid |
| P | low | 24.8 ppg (2.97 kg/L) | 8.4 ppg (1.01 kg/L) | 417 mL/min | 89.9% |
| P | low | 24.8 ppg (2.97 kg/L) | 8.4 ppg (1.01 kg/L) | 1071 mL/min | 86.1% |
| P | low | 24.8 ppg (2.97 kg/L) | 8.4 ppg (1.01 kg/L) | 2143 mL/min | 55.7% |
| Q | medium | 15.3 ppg (1.83 kg/L) | 8.4 ppg (1.01 kg/L) | 107 mL/min | 89.0% |

* The abbreviation “ppg” stands for pounds per gallon.

These results show that the recovery of kill fluid P decreases with increasing injection rate. It also shows that kill fluid P and kill fluid Q gave similar recoveries when kill fluid P was injected at 417 mL/min and kill fluid Q was injected at 107 mL/min Higher recovery yields indicate more efficient settling of the kill fluid.

### EXAMPLE 7

The ability of several brominated kill fluids to displace drilling mud in an annulus was studied in a 20 foot (6.1 m) tall 316 stainless steel column constructed with an 8 inch (20.3 cm) schedule 10 steel outer and a 6-inch (15.2 cm) schedule 10 steel inner pipe. The annulus had a 20 gallon (75.7 L) capacity and was connected to ten 0.25-inch (0.64 cm) nitrogen breathers at the bottom. There was a 2.25-inch (5.7 cm) diameter hole at the top of the inner pipe to allow the material in the annulus to overflow into the inner pipe during displacement. The column was equipped with a pressure transducer located at the bottom of the annulus in order to measure the hydrostatic pressure of the fluids in the annulus. Three kill fluids, all of which were mixtures, were prepared:

| | |
|---|---|
| R | brominated vegetable oil (38 wt % bromine), 38.2 wt %; and 1,1,2,2- |
| | tetrabromoethane, 61.8 wt % |
| S | brominated vegetable oil (38 wt % bromine), 20.4 wt %; and 1,1,2,2- |
| | tetrabromoethane, 79.6 wt % |
| T | brominated vegetable oil (38 wt % bromine), 7.2 wt %; and 1,1,2,2- |
| | tetrabromoethane, 92.8 wt %. |

All of these kill fluids were formed by stirring the two components together for several minutes.

For each experiment, the annulus was filled with 20 gallons (L) of an 11 ppg (1.32 kg/L) water-based drilling mud containing bentonite and barium sulfate with a plastic viscosity in the range of 57 to 60 lb_{f}·s/100 ft² (2.78 to 2.93 kg_{f}·s/m²). The drilling mud was allowed to sit in the annulus for 2 hours before nitrogen was bubbled into the mud through the nitrogen breathers at the bottom of the annulus. The nitrogen was bubbled for 15 minutes. After bubbling was discontinued, the kill fluid was injected for the displacement experiment. All of the kill fluids (an average of 20.1 gallons or 75.7 L) were injected into the mud-filled annulus via a 0.5-inch (1.3 cm) injection port located 4 feet (1.22 m) from the top of the column The hydrostatic pressure reading at the end of the experiment was compared to the theoretical hydrostatic pressure of a kill fluid-filled annulus in order to calculate a pressure efficiency. A high pressure efficiency correlates to an efficient mud displacement by the kill fluid. Results are summarized in Table 7.

TABLE 7

| Kill | Density | | | Pressure |
|---|---|---|---|---|
| fluid | Kill fluid^{a} | Drilling mud^{a} | Injection rate | efficiency |
| R | 17 ppg (2.04 kg/L) | 11 ppg (1.32 kg/L) | 1.05 gal/min (4.0 L/min) | 87% |
| S | 20 ppg (2.40 kg/L) | 11 ppg (1.32 kg/L) | 1.00 gal/min (3.8 L/min) | 93% |
| T | 23 ppg (2.76 kg/L) | 11 ppg (1.32 kg/L) | 0.95 gal/min (3.6 L/min) | 95% |

* The abbreviation “ppg” stands for pounds per gallon.

These results show that the brominated kill fluids tested are capable of displacing drilling mud from the annulus of a 20 foot (6.1 m) column. The pressure efficiency increases with increasing density of the kill fluid when settling through a drilling mud of a lower density and injecting the kill fluid at similar rates.

### EXAMPLE 8

The corrosivity of various brominated kill fluids against carbon steel was investigated. The tests were carried out for 35 days on C1018 carbon steel coupons in laboratory glassware at temperatures ranging from 21° C. to 120° C. The tests were run with either a neat kill fluid, or in a biphasic manner, in which both the kill fluid and a drilling mud containing bentonite and barium sulfate (drilling mud density: 14.5 ppg or 1.74 kg/L) were in contact with the carbon steel coupon. Results are summarized in Table 8.

TABLE 8

| | Amount | | |
|---|---|---|---|
| Brominated compound | drilling mud | Temp. | Corrosion rate^{a} |
| Brominated vegetable oil | 20 wt % | 21° C. | <1 mpy (<0.254 mm/yr) |
| (38 wt % bromine), 80 wt % | | | |
| 1,3-dibromobenzene, 80 wt % | 20 wt % | 21° C. | <1 mpy (<0.254 mm/yr) |
| 1,1,2,2-tetrabromoethane, 80 wt % | 20 wt % | 21° C. | 9 mpy (0.229 mm/yr) |
| 1,3-dibromobenzene, 77 wt % | 23 wt % | 90° C. | <1 mpy (<0.254 mm/yr) |
| 2,5-dibromothiophene, 80 wt % | 20 wt % | 90° C. | <1 mpy (<0.254 mm/yr) |
| 1,1,2-tribromoethylene | 0 | 120° C. | <1 mpy (<0.254 mm/yr) |
| Brominated vegetable oil | 0 | 120° C. | 2 mpy (0.051 mm/yr) |
| (38 wt % bromine) | | | |
| 1,1,2,2-tetrabromoethane | 0 | 120° C. | 12 mpy (0.305 mm/yr) |

^{a}The abbreviation “mpy” stands for mils penetration per year, and a mil is equal to one one-thousandth of an inch.

These results show that biphasic mixtures containing brominated vegetable oil and 1,3-dibromobenzene were less corrosive than the biphasic mixture containing 1,1,2,2-tetrabromoethane at 21° C. The biphasic mixtures containing 1,3-dibromobenzene or 2,5-dibromothiophene had low corrosion rates (less than 1 mpy at 90° C.). The lowest corrosion rate of the neat fluids tested at 120° C. was found for 1,1,2-tribromoethylene; brominated vegetable oil was less corrosive than 1,1,2,2-tetrabromoethane at 120° C.

Components referred to by chemical name or formula anywhere in the specification or claims hereof, whether referred to in the singular or plural, are identified as they exist prior to coming into contact with another substance referred to by chemical name or chemical type (e.g., another component, a solvent, or etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

The invention may comprise, consist, or consist essentially of the materials and/or procedures recited herein.

As used herein, the term “about” modifying the quantity of an ingredient in the compositions of the invention or employed in the methods of the invention refers to variation in the numerical quantity that can occur, for example, through typical measuring and liquid handling procedures used for making concentrates or solutions in the real world; through inadvertent error in these procedures; through differences in the manufacture, source, or purity of the ingredients employed to make the compositions or carry out the methods; and the like. The term about also encompasses amounts that differ due to different equilibrium conditions for a composition resulting from a particular initial mixture. Whether or not modified by the term “about”, the claims include equivalents to the quantities.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

1. A method for minimizing or relieving a sustained casing pressure in an annulus of a wellbore, wherein the annulus contains a first fluid having a density, the method comprising introducing a second fluid into the annulus, wherein the second fluid has a density greater than the density of the first fluid and the second fluid is immiscible with the first fluid, characterized in that the second fluid comprises at least one halogen-containing organic compound, which halogen-containing organic compound has one or more halogen atoms selected from fluorine, chlorine, bromine, and iodine, with the proviso that at least one of the halogen atoms is chlorine, bromine, or iodine.

2. A method as in claim 1 wherein the halogen-containing compound is a bromine-containing organic compound, or wherein the halogen-containing compound is a chlorine-containing organic compound.

3. A method as in claim 2 wherein the bromine-containing organic compound is selected from the group consisting of brominated oils, brominated natural products, brominated fatty acids, brominated fatty esters, brominated oligomers and brominated polymers, bromine-containing aromatic compounds, bromine-containing nonaromatic organic compounds, bromine-containing ionic compounds, and mixtures of two or more of the foregoing.

4. (canceled)

5. A method as in claim 2 wherein the chlorine-containing organic compound is selected from the group consisting of chlorinated oils, chlorinated natural products, chlorinated fatty acids, chlorinated fatty esters, chlorinated oligomers and chlorinated polymers, chlorine-containing aromatic compounds, chlorine-containing nonaromatic organic compounds, chlorine-containing ionic compounds, and mixtures of two or more of the foregoing.

6. A method as in claim 1 wherein the halogen-containing compound is a mixed-halogen organic compound.

7. A method as in claim 1 wherein the second fluid is a mixture of two or more halogen-containing organic compounds.

8. A method as in claim 7 wherein at least one of the halogen-containing organic compounds in the mixture is a bromine-containing organic compound.

9. A method as in claim 7 wherein at least one of the halogen-containing organic compounds in the mixture is a chlorine-containing organic compound.

10. A method as in claim 7 wherein at least one of the halogen-containing organic compounds in the mixture is an iodine-containing organic compound.

11. A method as in claim 3 wherein the bromine-containing organic compound is a bromine-containing nonaromatic organic compound.

12. A method as in claim 11 wherein the bromine-containing nonaromatic organic compound is a bromine-containing straight-chain compound.

13. A method as in claim 12 wherein the bromine-containing straight-chain compound is 1,1,2-tribromoethylene.

14. A method as in claim 3 wherein the bromine-containing organic compound is a bromine-containing aromatic organic compound.

15. A method as in claim 14 wherein the bromine-containing aromatic organic compound is a bromine-containing heterocyclic aromatic compound.

16. A method as in claim 15 wherein the bromine-containing heterocyclic aromatic compound is 2,5-dibromothiophene.

17. A method as in claim 14 wherein the bromine-containing aromatic organic compound is a bromine-containing homocyclic aromatic compound.

18. A method as in claim 17 wherein the bromine-containing homocyclic aromatic compound comprises a mixture of one or more dibromobenzenes and one or more tribromobenzenes.

19. (canceled)

20. A method as in claim 1 wherein the introduction of the second fluid is continuous.

21. A method as in claim 1 wherein a portion of the first fluid is removed from the annulus.

22. (canceled)

23. A method as in claim 1 wherein the halogen-containing organic compound has a halogen content of about 20 wt % or more.

24. A method as in claim 1 wherein the second fluid has a density that is higher than the density of the first fluid by about 0.5 ppg (0.06 kg/L) or more.
